(19) United States
(12) Patent Application Publication
(10) Pub. No.: US 2025/0226168 A1
(43) Pub. Date: Jul. 10, 2025

(54) CIRCUIT PROTECTION DEVICE

(71) Applicant: KOA CORPORATION, Ina-shi, Nagano (JP)

(72) Inventors: Masashi KATO, Nagano (JP); Hiroshi ICHIKAWA, Nagano (JP); Koji MAENO, Nagano (JP); Kazuyuki KATO, Nagano (JP)

(73) Assignee: KOA CORPORATION, Ina-shi, Nagano (JP)

(21) Appl. No.: 18/700,203

(22) PCT Filed: Sep. 12, 2022
(86) PCT No.: PCT/JP2022/034080

§ 371 Date: Apr. 10, 2024

(30) Foreign Application Priority Data
Oct. 11, 2021 (JP) 2021-166878

(51) Int. Cl. H01H 85/055; H01H 85/143; H01H 85/165

(52) U.S. Cl. CPC H01H 85/055; H01H 85/143; H01H 85/165

(57) ABSTRACT

A circuit protection device includes a pair of electrode portions, an element portion provided between both of the electrode portions and a plate body arranged so as to extend along the element portion. The plate body is made of an insulator, and the circuit protection device further includes an exterior member configured to cover the element portion and the plate body.

### TECHNICAL FIELD

The present invention relates to a circuit protection device.

### BACKGROUND ART

JPH6-76728A discloses a circuit protection device. This circuit protection device includes a pair of electrodes, and a metal wire is arranged between both of the electrodes. One end of the metal wire is joined to one of the electrodes, and the other end of the metal wire is joined to the other electrode.

A low melting point glass body is provided around the metal wire, and the low melting point glass body is covered with a synthetic resin. The synthetic resin is molded by a molded resin body, and a molded case is formed of a molding resin.

### SUMMARY OF INVENTION

In such a circuit protection device, in order to allow passage of a large current, it is required to make the metal wire thick.

In a case in which the metal wire is made thicker, an impact caused when the metal wire is fused due to an overcurrent exceeding an allowable level is increased. In addition, the amount of heat generated from the metal wire when the metal wire is fused is increased.

Then, the amount of heat transmitted to the molded case when the metal wire is fused is increased. In addition, the low melting point glass body that has melted due to the heat generated by the fusion undergoes a thermal expansion, thereby increasing an internal pressure around the metal wire. Furthermore, the impact caused when the metal wire is fused is increased.

As a result, the molded case is deformed, and there is a risk in that an external shape of the circuit protection device cannot be maintained.

An object of the present invention is to provide a circuit protection device capable of suppressing change in an external shape.

A circuit protection device according to an aspect of the present invention is provided with: a pair of electrode portions; an element portion provided between both of the electrode portions; a plate body arranged so as to extend along the element portion, the plate body being made of an insulator; and an exterior member configured to cover the element portion and the plate body.

According to the circuit protection device of this aspect, the plate body is arranged so as to extend along the element portion, which is provided between the electrode portions, and the plate body is arranged between the element portion and the exterior member.

With such a configuration, the transmission of heat generated when the element portion is fused by the overcurrent is shielded by the plate body. Thus, the transmission of the heat generated when the element portion is fused to the exterior member is suppressed, and so, it is possible to suppress deformation of the exterior member due to the heat generated when the element portion is fused.

Therefore, according to an aspect of the present invention, it is possible to suppress change in an external shape of the circuit protection device.

### BRIEF DESCRIPTION OF DRAWINGS

FIG. 1 is a sectional view showing a circuit protection device according to a first embodiment.

FIG. 2 is a sectional view showing the circuit protection device according to the first embodiment cut along a plane corresponding to line A-A in FIG. 1.

FIG. 3 is a sectional view showing the circuit protection device according to the first embodiment cut along a plane corresponding to the line B-B in FIG. 2.

FIG. 4 is a sectional view showing the circuit protection device according to a second embodiment.

FIG. 5 is a sectional view showing the circuit protection device according to a third embodiment.

FIG. 6 is a plan view showing a plate body of the circuit protection device according to the third embodiment.

FIG. 7 is a plan view showing the plate body of the circuit protection device according to a fourth embodiment.

FIG. 8 is a plan view showing the plate body of the circuit protection device according to a fifth embodiment.

FIG. 9 is a plan view showing the plate body of the circuit protection device according to a sixth embodiment.

FIG. 10 is a plan view showing the plate body of the circuit protection device according to a seventh embodiment.

FIG. 11 is a plan view showing the plate body of the circuit protection device according to an eighth embodiment.

FIG. 12 is a sectional view showing the circuit protection device according to a nineth embodiment.

FIG. 13 is a sectional view showing the circuit protection device according to the nineth embodiment cut along a plane corresponding to the line C-C in FIG. 12.

FIG. 14 is a sectional view showing the circuit protection device according to a tenth embodiment.

### DESCRIPTION OF EMBODIMENTS

### First Embodiment

A first embodiment will be described with reference to the drawings.

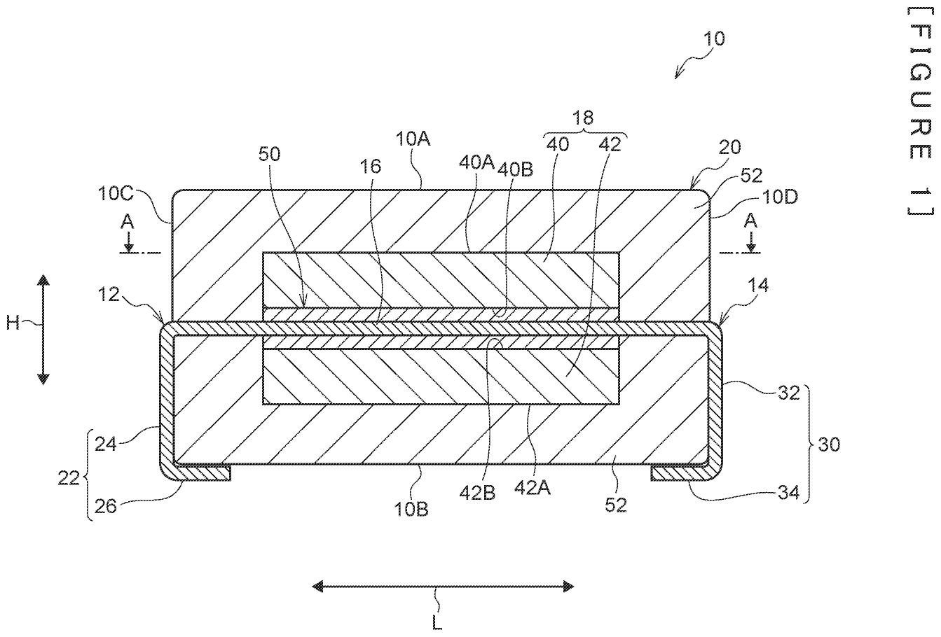

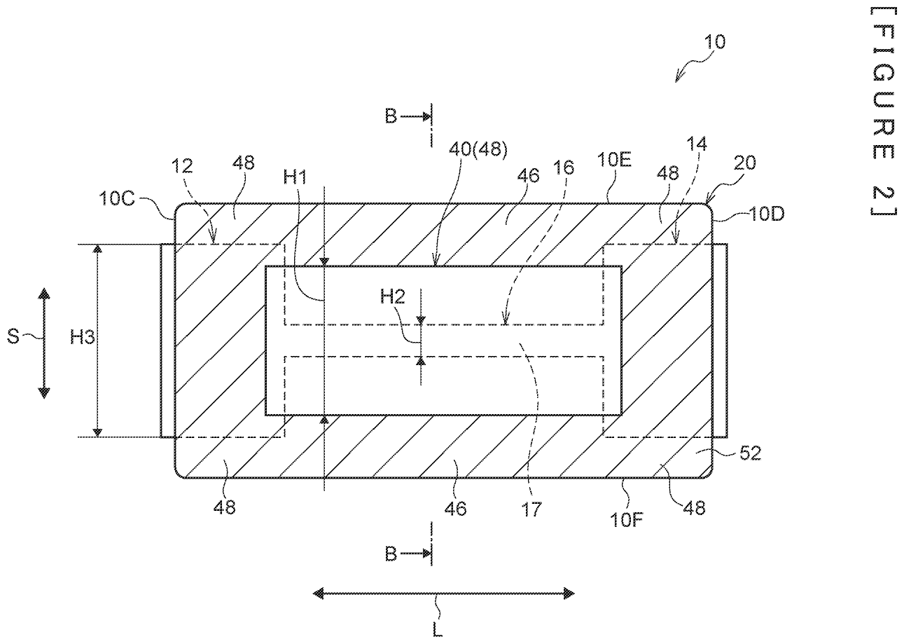

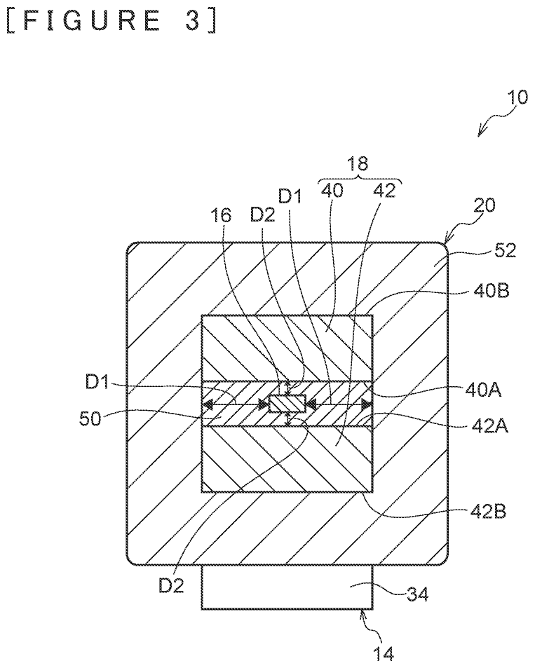

FIG. 1 is a sectional view showing a circuit protection device 10 according to the first embodiment. FIG. 2 is a sectional view showing the circuit protection device 10 cut along a plane corresponding to the line A-A in FIG. 1. FIG. 3 is a sectional view showing the circuit protection device 10 cut along a plane corresponding to the line B-B in FIG. 2.

The circuit protection device 10 is, as an example, a device that allows a flow of current to a circuit while preventing a flow of an overcurrent. The circuit protection device 10 acts as a conductor when a current of a level within a predetermined range flows therethrough. On the other hand, when a large current exceeding the allowable level flows through the circuit protection device 10, a fusible conductor is fused, and thereby, the circuit protection device 10 protects the circuit by cutting the current.

A large current circuit, through which a large current flows, is formed in an electric vehicle (EV), etc., and the circuit protection device 10 is also used in the large current circuit. The circuit protection device 10 as described above is required to be small in size and to have a performance to allow the flow of the large current.

As shown in FIGS. 1 and 2, as an example, the circuit protection device 10 is formed have to a size capable of being mounted on a printed circuit board.

The circuit protection device 10 is formed to have a horizontally-elongated rectangular parallelepiped shape. In the circuit protection device 10, a surface on the upper side in the height direction H forms an upper surface 10A of the rectangular parallelepiped shape, and a surface on the lower side in the height direction H forms a lower surface 10B.

In addition, in the circuit protection device 10, a surface on the first side in the longitudinal direction L forms a first side surface 10C of a rectangular shape, and a surface on the second side in the longitudinal direction L forms a second side surface 10D of the rectangular shape. Furthermore, in the circuit protection device 10, a surface on the first side in the lateral direction S forms a third side surface 10E of the rectangular parallelepiped shape, and a surface on the second side in the lateral direction S forms a fourth side surface 10F of the rectangular parallelepiped shape.

The circuit protection device 10 is provided with a first electrode portion 12 and a second electrode portion 14, an element portion 16 that is provided between both of the electrode portions 12 and 14, a plate body 18 that is made of an insulator and arranged so as to extend along the element portion 16, and an exterior member 20 that covers both of the element portion 16 and the plate body 18.

The electrode portions 12 and 14 and the element portion 16 are made of a single metal plate, and each of the electrode portions 12 and 14 and the element portion 16 are formed integrally. With such a configuration, compared with a case in which an element portion, which is formed as a separate component, is joined to each of the electrode portions, occurrence of a situation in which the element portion 16 and each of the electrode portions 12 and 14 are broken by repeated energization or vibration input during use is suppressed.

Specifically, the electrode portions 12 and 14 and the element portion 16 are made of an elongated metal plate. As the metal plate, a plate made of phosphor bronze having a low specific resistance is used. Phosphor bronze forming each of the electrode portions 12 and 14 and the element portion 16 is suitable for the passage of the large current.

As shown in FIG. 2, in the metal plate, both side edge portions are notched inwardly in a rectangular shape at the center in the longitudinal direction L. With such a configuration, at the center of the metal plate in the longitudinal direction L, a narrow portion 17 having narrower width dimension than that of each of the electrode portions 12 and 14 is formed, and the narrow portion 17 forms the element portion 16.

A part of the metal plate on the first side relative to the narrow portion 17 forms the first electrode portion 12 that is wider than the narrow portion 17. In addition, a part of the metal plate on the second side relative to the narrow portion 17 forms the second electrode portion 14 that is wider than the narrow portion 17.

### Element Portion

The element portion 16 has a narrower width and a smaller cross-sectional area than each of the electrode portions 12 and 14. Therefore, the current flowing between both of the electrode portions 12 and 14 has a higher current density than the current flowing in the element portion 16. As a result, if the current exceeding a predetermined current value flows through the element portion 16, the element portion 16 heats up and melts down.

The element portion 16 is arranged at the center of the circuit protection device 10 in the longitudinal direction L and at the center of the circuit protection device 10 in the lateral direction S. In addition, the element portion 16 is arranged at the center of the circuit protection device 10 in the height direction H.

### Electrode Portion

As shown in FIG. 1, an end portion of the first electrode portion 12 extends out from the first side surface 10C of the circuit protection device 10, and this extending portion forms a first extending portion 22.

A base end portion of the first extending portion 22 is bent along the first side surface 10C, and the first extending portion 22 is provided with a first side-surface extended portion 24 that extends along the first side surface 10C. A tip-end portion of the first side-surface extended portion 24 of the first extending portion 22 is bent along the lower surface 10B, and the first extending portion 22 is provided with a first lower-surface extended portion 26 that extends along the lower surface 10B.

An end portion of the second electrode portion 14 extends out from the second side surface 10D of the circuit protection device 10, and this extending portion forms a second extending portion 30.

A base end portion of the second extending portion 30 is bent along the second side surface 10D, and the second extending portion 30 is provided with a second side-surface extended portion 32 that extends along the second side surface 10D. A tip-end portion of the second side-surface extended portion 32 of the second extending portion 30 is bent along the lower surface 10B, and the second extending portion 30 is provided with a second lower-surface extended portion 34 that extends along the lower surface 10B.

With such a configuration, the lower surface 10B of the circuit protection device 10 is provided with the first lower-surface extended portion 26 of the first electrode portion 12 and the second lower-surface extended portion 34 of the second electrode portion 14.

By arranging the lower surface 10B of the circuit protection device 10 so as to oppose to the printed circuit board, the respective lower-surface extended portions 26 and 34 of the electrode portions 12 and 14 can be aligned with lands on the printed circuit board. Thus, by joining the respective lower-surface extended portions 26 and 34 of the electrode portions 12 and 14 to the lands on the printed circuit board, it is possible to surface mount the circuit protection device 10 to the printed circuit board.

### Plate Body

The plate body 18 includes a first plate body 40 that is arranged on the upper side, which is the first side, of the element portion 16, and a second plate body 42 that is arranged on the lower side, which is the second side, of the element portion 16.

Each of the plate bodies 40 and 42 has the rectangular parallelepiped shape, and both of the plate bodies 40 and 42 have the same shape. Each of the plate bodies 40 and 42 is made of a different material from the exterior member 20, and when the exterior member 20 of the same thickness as each of the plate bodies 40 and 42 is assumed, the strength of each of the plate bodies 40 and 42 is higher than that of the assumed exterior member 20.

Each of the plate bodies 40 and 42 is made of an inorganic material, and so, carbonization of each of the plate bodies 40 and 42 is suppressed. The inorganic material forming each of the plate bodies 40 and 42 includes inorganic materials such as ceramics such as alumina, glass, and so forth.

As shown in FIG. 2, each of the plate bodies 40 and 42 covers the element portion 16 over its entire length and covers a part of the first electrode portion 12 and a part of the second electrode portion 14. The width dimension Hl of each of the plate bodies 40 and 42 is wider than the width dimension H2 of the element portion 16 and narrower than the width dimension H3 of each of the electrode portions 12 and 14.

The separated distance from each side edge of each of the plate bodies 40 and 42 to the third side surface 10E or the fourth side surface 10F of the circuit protection device 10 is greater than the separated distance from each side edge of each of the electrode portions 12 and 14 to the third side surface 10E or the fourth side surface 10F.

The upper and lower parts of the exterior member 20, divided by each of the electrode portions 12 and 14 and the element portion 16, are formed of first connecting portions 46, which are formed on both sides of each of the plate bodies 40 and 42 and the element portion 16, and second connecting portions 48, which are formed on both sides of each of the electrode portions 12 and 14. The width dimension of the first connecting portions 46 in the lateral direction S is larger than the width dimension of the second connecting portions 48 in the lateral direction S.

As shown in FIG. 3, each of the plate bodies 40 and 42 is fixed to the element portion 16 and each of the electrode portions 12 and 14 via an inorganic adhesive 50.

Specifically, the first plate body 40 and the second plate body 42 are arranged such that their respective back surfaces 40A and 42A oppose to the element portion 16 and such that their respective front surfaces 42B and 42B face away from the element portion 16. Each of the plate bodies 40 and 42 is fixed to the element portion 16 with the adhesive 50 on the respective back surfaces 40A and 42A, and thereby, the element portion 16 is sandwiched by both of the plate bodies 40 and 42 from above and below.

Each of the plate bodies 40 and 42 suppresses the transmission of the heat generated when the element portion 16 is fused. In addition, each of the plate bodies 40 and 42 suppresses the transmission of the pressure caused by the thermal expansion that may occur when the element portion 16 is fused. Furthermore, each of the plate bodies 40 and 42 suppresses the transmission of the impact generated when the element portion 16 is fused.

Therefore, each of the plate bodies 40 and 42 can be referred to as a shock absorbing member that suppresses the transmission of the pressure or impact to the exterior member 20 or as an explosion-proof member that suppresses the deformation and destruction of the exterior member 20 due to the pressure.

The element portion 16 is surrounded by the adhesive 50 that has been solidified. The distance D1 from the side surface of the element portion 16 to the side surface of the adhesive 50 is greater than the distance D2 from the upper surface or lower surface of the element portion 16 to each of the plate bodies 40 and 42.

The adhesive 50 for fixing each of the plate bodies 40 and 42 is made of the inorganic material. Thus, even if the adhesive 50 is subjected to the heat generated when the element portion 16 is fused, the carbonization of the adhesive 50 is suppressed, and thereby, the fused element portion 16 is prevented from being electrically connected through a carbonized material.

### (Exterior Member)

The exterior member 20 is made of a molding material 52 that surrounds and comes into close contact with both of the plate bodies 40 and 42, each of the electrode portions 12 and 14, and the adhesive 50, and thereby, the exterior member 20 forms the external shape of the circuit protection device 10.

The molding material 52 is made of, as an example, a synthetic resin, and the exterior member 20 formed by the molding material 52 covers each of the electrode portions 12 and 14, the element portion 16, and each of the plate bodies 40 and 42 from the outer periphery.

In this embodiment, although a description will be given of a case in which the exterior member 20 is made of the molding material 52, this embodiment is not limited thereto. For example, the exterior member 20 may be a container-like shape that covers the element portion 16 and each of the plate bodies 40 and 42.

### Operations and Effects

Next, the operational advantages of this embodiment will be described.

The circuit protection device 10 of this embodiment is provided with the electrode portions 12 and 14, the element portion 16 that is provided between both of the electrode portions 12 and 14, the plate body 18 that is made of the insulator and arranged so as to extend along the element portion 16, and the exterior member 20 that covers the element portion 16 and the plate body 18.

According to this configuration, the plate body 18 is arranged so as to extend along the element portion 16 that is provided between the electrode portions 12 and 14, and the plate body 18 is arranged between the element portion 16 and the exterior member 20.

Thus, the transmission of the heat when the element portion 16 is fused due to the overcurrent is shielded by the plate body 18. As a result, the transmission of the heat generated when the element portion 16 is fused to the exterior member 20 is suppressed, and thereby, it is possible to suppress the deformation of the exterior member 20 due to the heat generated when the element portion 16 is fused.

In addition, even in a case in which the members such as the adhesive 50 that is provided on the outer peripheral portions of the element portion 16, the molding material 52 that has entered between both of the plate bodies 40 and 42, or the like are melted and thermally expanded, it is possible to prevent the transmission of the pressure caused by the thermal expansion with the plate body 18. Furthermore, it is possible to suppress the transmission of the impact that is caused when the element portion 16 is fused with the plate body 18.

Thus, compared with a case in which the pressure generated by the thermal expansion or the impact caused at the time of the fusion is directly transmitted to the exterior member 20, it is possible to suppress the deformation of the exterior member 20.

Therefore, it is possible to enable suppression of the change in the external shape of the circuit protection device 10.

Especially, even in a case in which the element portion 16 that allows the flow of the large current is employed in the circuit protection device 10 to enable its use in the large current circuit, it is possible to enable suppression of the change in the external shape of the circuit protection device 10.

In addition, in the circuit protection device 10 of this embodiment, the plate body 18 includes the first plate body 40 that is arranged on the first side of the element portion 16 and the second plate body 42 that is arranged on the second side of the element portion 16.

According to this configuration, it is possible to suppress the shape change on the first side of the element portion 16 with the first plate body 40, and it is possible to suppress the shape change on the second side of the element portion 16 with the second plate body 42.

Thus, there is no need to provide a deformation suppression structure on the second side of the element portion 16, as is the case when the plate body 18 is arranged only on the first side of the element portion 16. Specifically, there is no need to maintain the appearance quality on the second side of the circuit protection device 10 by increasing the thickness of the exterior member 20 on the second side of the element portion 16, or by arranging the second side of the element portion 16 on the side of the printed circuit board, and therefore, the convenience is improved.

In addition, in the circuit protection device 10 of this embodiment, the plate body 18 is made of the inorganic material.

According to this configuration, the plate body 18, which is arranged so as to extend along the element portion 16 and which may be subjected to the heat generated when the element portion 16 is fused, is made of the inorganic material, and so, even if the plate body 18 is subjected to the heat generated when the element portion 16 is fused, the carbonization of the plate body 18 is suppressed.

Thus, it is possible to suppress, in advance, a situation in which the plate body 18 is carbonized by the heat generated when the element portion 16 is fused, and the element portion 16 that has been fused is electrically connected through the thus-carbonized plate body 18.

In addition, in the circuit protection device 10 of this embodiment, the element portion 16 is formed of the narrow portion 17 formed in the elongated metal plate. In addition, the electrode portions include the first electrode portion 12 formed on the first side of the metal plate bounded by the narrow portion 17 and the second electrode portion 14 formed on the the second side of the metal plate bounded by the narrow portion 17.

According to this configuration, it is possible to integrally form the element portion 16 and each of the electrode portions 12 and 14.

Thus, compared with a case in which the element portion 16, which formed as a separate component, is joined to each of the electrode portions 12 and 14, there is no need to perform an operation of joining the element portion 16 to each of the electrode portions 12 and 14.

In addition, compared with a case in which the element portion 16 is joined to each of the electrode portions 12 and 14, it is possible to suppress disconnection that may be caused between the element portion 16 and each of the electrode portions 12 and 14 due to the repeated energization or the vibration input during the use for the circuit protection device 10.

In addition, in the circuit protection device 10 of this embodiment, the element portion 16 is made of phosphor bronze.

According to this configuration, the element portion 16 is made of phosphor bronze having a low specific resistance. Therefore, it is possible to increase the current that is allowed to flow between the electrode portions 12 and 14.

In addition, in the circuit protection device 10 of this embodiment, the plate body 18 is fixed to the element portion 16 via the inorganic adhesive 50.

According to this configuration, because the heat generated when the element portion 16 is fused is transmitted to the plate body 18 via the adhesive 50, it is possible to improve a durability of the plate body 18. In addition, because the adhesive 50 is disposed between the element portion 16 and the plate body 18, it is possible to increase a durability of the circuit protection device 10 against the impact that may be caused at the time of the fusion.

The adhesive 50 that fixes the plate body 18 to the element portion 16 is made of the inorganic material, and so, the carbonization of the adhesive 50 when it is subjected to the heat generated when the element portion 16 is fused is suppressed.

Thus, it is possible to suppress, in advance, a situation in which the adhesive 50 is carbonized by the heat generated when the element portion 16 is fused, and the element portion 16 that has been fused is electrically connected through the thus-carbonized adhesive 50.

### Second Embodiment

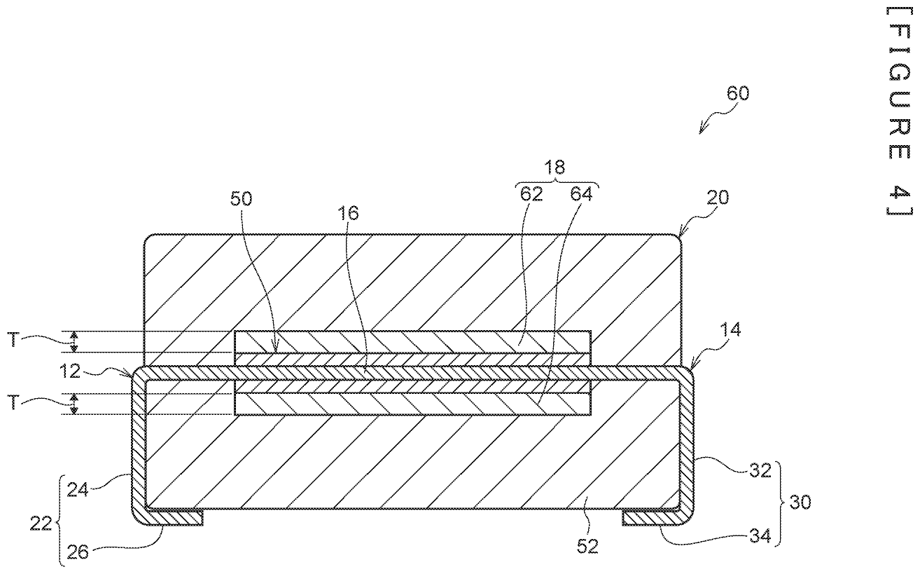

FIG. 4 is a sectional view showing a circuit protection device 60 according to a second embodiment, and the second embodiment will be described with reference to FIG. 4. Components that are the same as or similar to those in the first embodiment will be assigned the same reference numerals, and a description thereof shall be omitted. Description will be given of components that are different from those in the first embodiment.

In the circuit protection device 60 according to the second embodiment, compared with the circuit protection device 10 in the first embodiment, the thickness T of each of plate bodies 62 and 64 is different.

In other words, in the circuit protection device 60 according to the second embodiment, the plate thickness T of each of the plate bodies 62 and 64 is set to 100 um or less.

The lower limit value of the plate thickness T of each of the plate bodies 62 and 64 is determined by the material used to form each of the plate bodies 62 and 64. As an example, a range of the plate thickness T is set to be from 50 μm to 100 μm, inclusive. In addition, in this embodiment, the plate thickness T of the each plate body is set to 100 μm.

### Operations and Effects

Next, the operational advantages of this embodiment will be described.

Also in this embodiment, for the configurations that are the same as or similar to those in the first embodiment, it is possible to achieve the operational advantages similar to those in the first embodiment.

In addition, in the circuit protection device 10 of this embodiment, each of the plate bodies 62 and 64 has the plate thickness T of 100 μm or less.

According to this configuration, because each of the plate bodies 62 and 64 has the plate thickness T of 100 μm or less, each of the plate bodies 62 and 64 can be made more susceptible to cracking by the pressure due to the thermal expansion that is caused when the element portion 16 is fused or the impact that is caused when the element portion 16 is fused. Consequently, by cracking, each of the plate bodies 62 and 64 absorbs the energy released when the element portion 16 is fused.

Thus, compared with the circuit protection device in which the plate body 18 is less prone to cracking because the plate thickness T exceeds 100 μm, it is possible to improve the effect of preventing the deformation of the exterior member 20.

### Third Embodiment

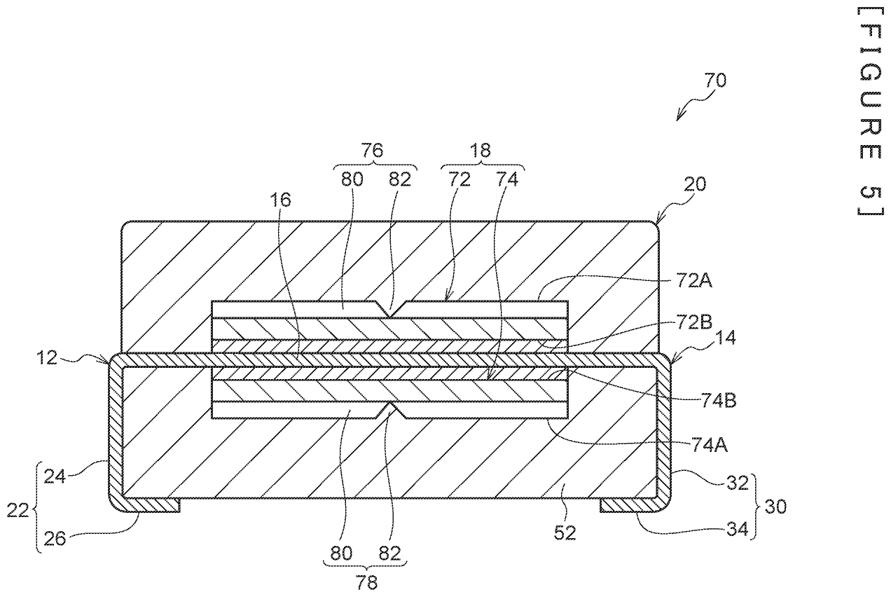

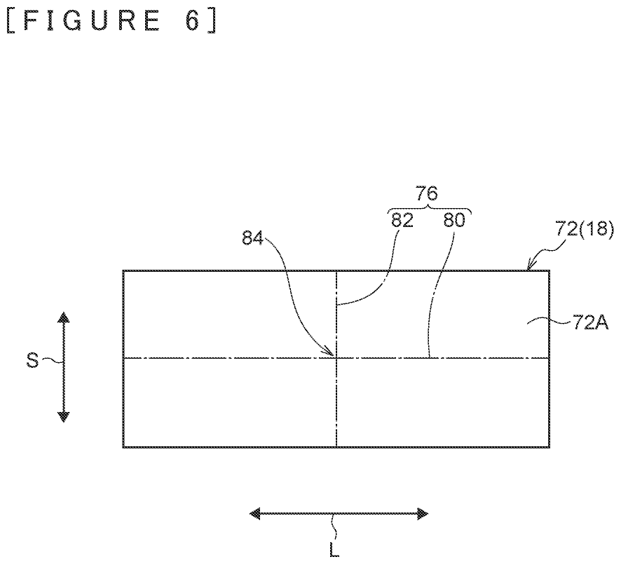

FIG. 5 is a sectional view showing a circuit protection device 70 according to a third embodiment. FIG. 6 is a plan view showing the plate body 18 of the circuit protection device 70 according to the third embodiment. The third embodiment will be described with reference to FIGS. 5 and 6. Components that are the same as or similar to those in the respective embodiments described above will be assigned the same reference numerals, and a description thereof shall be omitted. Description will be given of components that are different from those in the respective embodiments described above.

In the circuit protection device 70 according to the third embodiment, compared with the circuit protection device 10, 60 in the respective embodiments described above, the structures of front surfaces 72A and 74A of respective plate bodies 72 and 74 are different. In other words, in the circuit protection device 70 according to the third embodiment, the plate bodies 72 and 74 have grooves 76 and 78 on the front surfaces 72A and 74A, respectively.

As shown in FIG. 6 (only the plate body 72 on one side is shown), the groove 76 (78) in the front surface 72A (74A) of the plate body 72 (74) is formed of a long groove 80 that extends in the longitudinal direction L of the plate body 72 (74) and a short groove 82 that extends in the lateral direction S of the plate body 72 (74). The long groove 80 and the short groove 82 intersect (orthogonally) at the center of the plate body 72 (74), and this intersection part 84 is arranged so as to be positioned at the center of the element portion 16.

In addition, each of the grooves 80 and 82 is formed so as to have a V-shaped cross-sectional shape, and the plate body 72 (74) has a thinner plate thickness at the bottom of each of the grooves 80 and 82.

### Operations and Effects

Next, the operational advantages of this embodiment will be described.

Also in this embodiment, for the configurations that are the same as or similar to those in the respective embodiments described above, it is possible to achieve the operational advantages similar to those in the respective embodiments described above.

In addition, the plate bodies 72 and 74 of the circuit protection device 70 of this embodiment have the grooves 76 and 78, respectively, in the front surfaces 72A and 74A.

According to this configuration, the plate bodies 72 and 74 have the grooves 76 and 78, respectively, in the front surfaces 72A and 74A. Therefore, even if the plate thickness of each of the plate bodies 72 and 74 is not made thin, each of the plate bodies 72 and 74 can be made more susceptible to cracking by the pressure due to the thermal expansion that is caused when the element portion 16 is fused or the impact that is caused when the element portion 16 is fused. Consequently, by cracking, each of the plate bodies 72 and 74 absorbs the energy released when the element portion 16 is fused.

Thus, compared with a case in which a plate body that does not have a groove in a surface and that is less prone to cracking is used, it is possible to improve the effect of preventing the deformation of the exterior member 20.

In this embodiment, the long groove 80 and the short groove 82 intersect at the center of each of the plate bodies 72 and 74, and the intersection part 84 is arranged so as to be positioned at the center of the element portion 16.

Thus, compared with a case in which the intersection part 84 is arranged at a position away from the center of the element portion 16, each of the plate bodies 72 and 74 can further be made more susceptible to cracking.

In this embodiment, although a description has been given of a case in which the grooves 76 and 78 are respectively formed in the front surfaces 72A and 74A of the plate bodies 72 and 74, this embodiment is not limited thereto. For example, grooves may be formed in back surfaces 72B and 74B of the plate bodies 72 and 74, or the grooves may be formed in the front surfaces 72A and 74A and the back surfaces 72B and 74B.

In addition, in this embodiment, although a description has been given of a case in which a single short groove 82 is formed, this embodiment is not limited to this structure.

For example, the circuit protection device may also be configured as shown in a fourth embodiment and a fifth embodiment.

### Fourth Embodiment

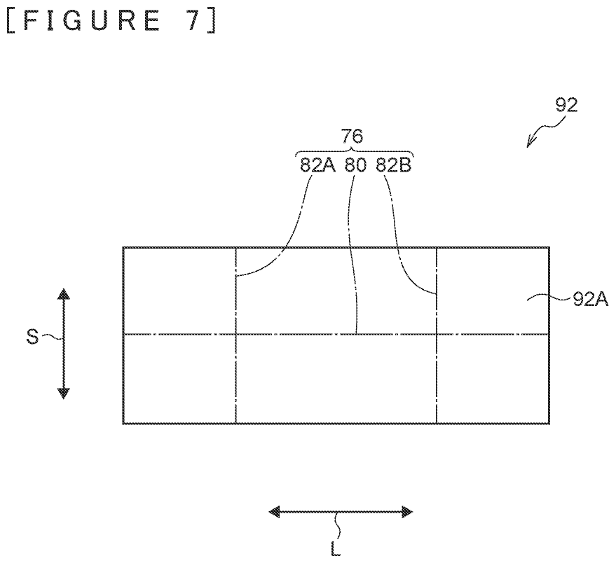

FIG. 7 is a plan view showing a plate body 92 of the circuit protection device according to the fourth embodiment.

In a front surface 92A of the plate body 92 of the circuit protection device according to the fourth embodiment, two short grooves 82A and 82B are formed so as to be spaced apart from each other.

### Fifth Embodiment

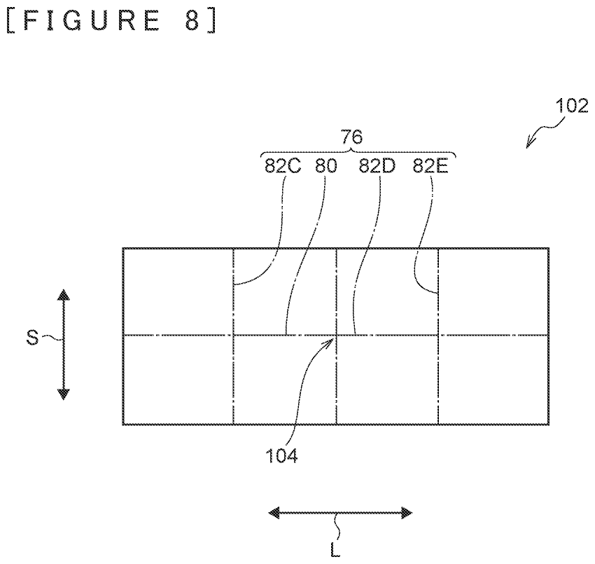

In addition, FIG. 8 is a plan view showing a plate body 102 of the circuit protection device according to the fifth embodiment.

In the plate body 102 of the circuit protection device according to the fifth embodiment, three short grooves 82C, 82D, and 82E are formed so as to be spaced apart from each other, and an intersection part 104 between the short groove 82D, which is arranged at the middle, and the long groove 80 is arranged so as to be positioned at the center of the element portion 16.

### Operations and Effects

Next, the operational advantages of this embodiment will be described.

Also in the circuit protection device according to the fourth embodiment and the circuit protection device according to the fifth embodiment, it is possible to achieve the operational advantages similar to those in the third embodiment.

In the third to fifth embodiments, although a description has been given of a case in which the long groove 80 is formed so as to pass through the center of each of the plate body 18, 92, 102 in the lateral direction S, this embodiment is not limited to these structures.

For example, the circuit protection device may also be configured as shown in a sixth embodiment and a seventh embodiment.

### Sixth Embodiment

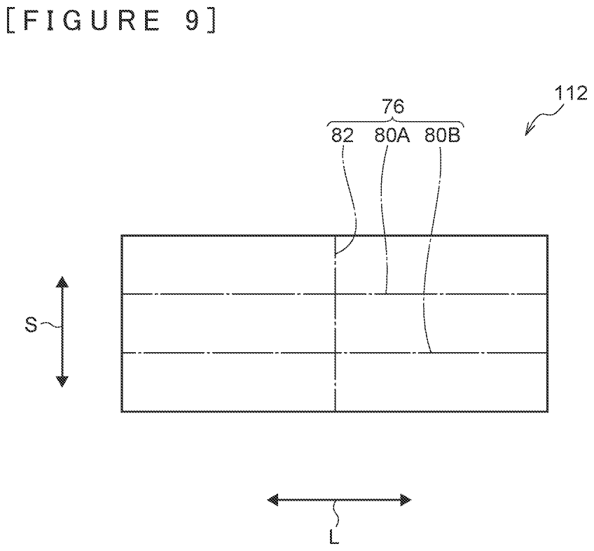

FIG. 9 is a plan view showing a plate body 112 of the circuit protection device according to the sixth embodiment.

The plate body 112 of the circuit protection device according to the sixth embodiment differs from that of the third embodiment in that two long grooves 80A and 80B are formed so as to be spaced apart from each other.

### Seventh Embodiment

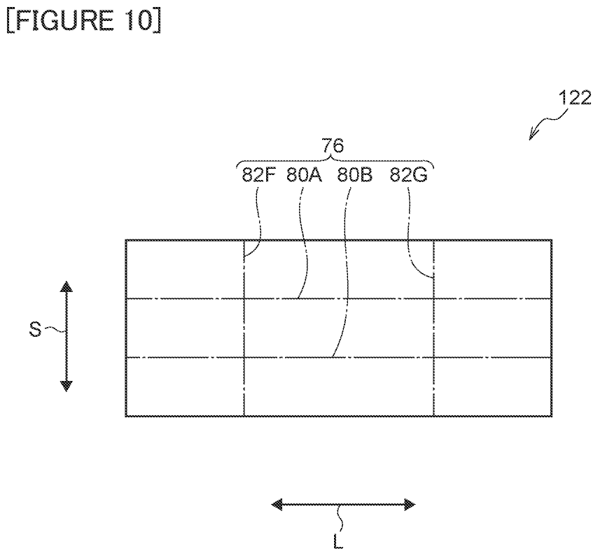

In addition, FIG. 10 is a plan view showing a plate body 122 of the circuit protection device according to the seventh embodiment.

The plate body 122 of the circuit protection device according to the seventh embodiment differs from that of the sixth embodiment in that two short grooves 82F and 82G are formed so as to be spaced apart from each other.

### Operations and Effects

Next, the operational advantages of this embodiment will be described.

Also in the circuit protection device according to the sixth embodiment and the circuit protection device according to the seventh embodiment, it is possible to achieve the operational advantages similar to those in the third to fifth embodiments.

In the third to seventh embodiments, a description has been given of a case in which the long groove 80, 80A, 80B extends in the longitudinal direction L of the plate body 18, 92, 102, 110, 122. Furthermore, in the third to seventh embodiments, although a description has been given of a case in which the short groove 82, 82A-82G extends in the lateral direction S, this embodiment is not limited to this structure.

For example, the circuit protection device may also be configured as shown in an eighth embodiment.

### Eighth Embodiment

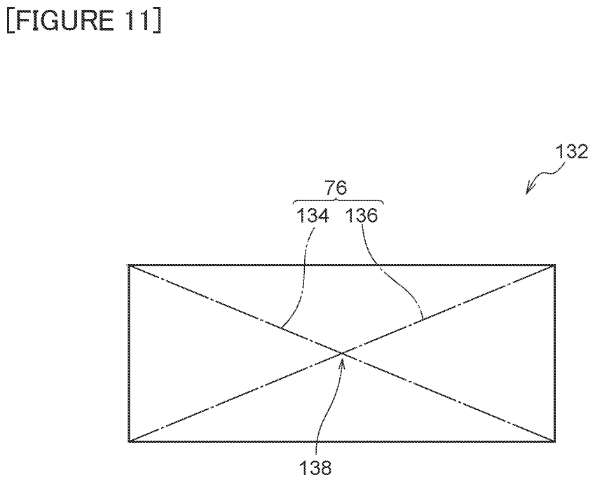

FIG. 11 is a plan view showing a plate body 132 of the circuit protection device according to the eighth embodiment.

The plate body 132 of the circuit protection device according to the eighth embodiment differs from those of the third to seventh embodiments in that the groove 76 is formed of two diagonal grooves 134 and 136 that extend in the diagonal directions with respect to the plate body 18, 92, 102, 110, 122. In addition, an intersection part 138 between the two diagonal grooves 134 and 136 is arranged so as to be positioned at the center of the element portion 16.

### Operations and Effects

Next, the operational advantages of this embodiment will be described.

Also in the circuit protection device according to the eighth embodiment, it is possible to achieve the operational advantages similar to those in the third to seventh embodiments.

### Nineth Embodiment

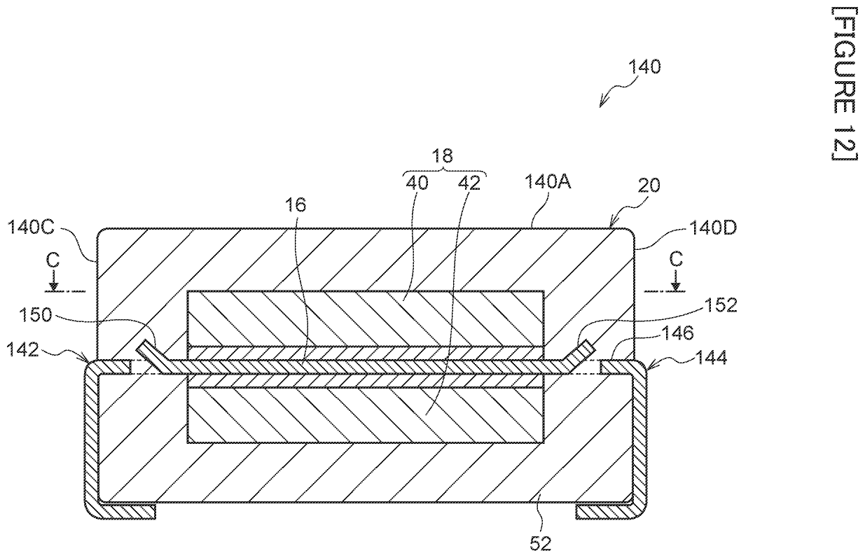

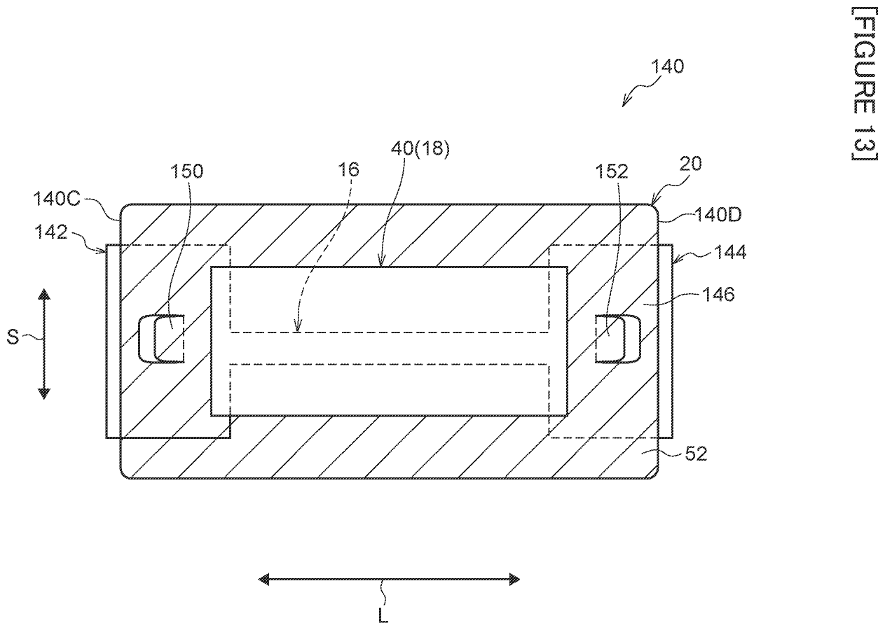

FIG. 12 is a sectional view showing a circuit protection device 140 according to a nineth embodiment. FIG. 13 is a sectional view showing the circuit protection device 140 cut along a plane corresponding to the line C-C in FIG. 12. The nineth embodiment will be described with reference to FIGS. 12 and 13.

Components that are the same as or similar to those in the respective embodiments described above will be assigned the same reference numerals, and a description thereof shall be omitted. Description will be given of components that are different from those in the respective embodiments described above.

In the circuit protection device 140 according to the nineth embodiment, compared with the circuit protection device 10, 60, 70 in the respective embodiments described above, the structure of each of electrode portions 142 and 144 is different.

In other words, in the circuit protection device 140 according to the nineth embodiment, the electrode portions 142 and 144 are respectively provided with a first tab 150 and a second tab 152, each of which projects out from a first surface 146 on the upper side of the electrode portions 142 and 144 so as to be inserted into the molding material 52 forming the exterior member 20. The tabs 150 and 152 each projects out from each of the electrode portions 142 and 144 towards an upper surface 140A side of the exterior member 20.

Specifically, a part of the first electrode portion 142 that is arranged within the exterior member 20 is formed of a cut-bent part that is cut and bent so as to be oriented towards the upper surface 140A of the circuit protection device 140, and this cut-bent part forms the first tab 150.

The first tab 150 is formed by cutting a U-shaped slit in the first electrode portion 142 and by bending an inner part of this slit. Then, by embedding the first tab 150 into the molding material 52 forming the exterior member 20, the connection between a part of the exterior member 20 positioned above the first electrode portion 142 and the first electrode portion 142 is reinforced.

The first tab 150 is formed at the center of the first electrode portion 142 in the lateral direction S, and the first tab 150 is inclined towards a first side surface 140C as it approaches the upper surface 140A of the circuit protection device 140.

In addition, a part of the second electrode portion 144 that is arranged within the exterior member 20 is formed of a cut-bent part that is cut and bent so as to be oriented towards the upper surface 140A of the circuit protection device 140, and this cut-bent part forms the second tab 152.

The second tab 152 is formed by cutting a U-shaped slit in the second electrode portion 144 and by bending an inner part of this slit. Then, by embedding the second tab 152 into the molding material 52 forming the exterior member 20, the connection between a part of the exterior member 20 positioned above the second electrode portion 144 and the second electrode portion 144 is reinforced.

The second tab 152 is formed at the center of the second electrode portion 144 in the lateral direction S, and the second tab 152 is inclined towards a second side surface 140D as it approaches the upper surface 140A of the circuit protection device 140.

### Operations and Effects

Next, the operational advantages of this embodiment will be described.

Also in this embodiment, for the configurations that are the same as or similar to those in the respective embodiments described above, it is possible to achieve the operational advantages similar to those in the respective embodiments described above.

In addition, the exterior member 20 of the circuit protection device 140 in this embodiment is made of the molding material 52 that is in close contact with each of the plate bodies 40 and 42 and each of the electrode portions 142 and 144. In addition, the electrode portions 142 and 144 are each provided with each of the tabs 150 and 152 that projects out from the first surface 146 of each of the electrode portions 142 and 144 so as to be inserted into the molding material 52.

According to this configuration, even if the pressure and the impact generated when the element portion 16 is fused are applied to the part of the exterior member 20 positioned above each of the electrode portions 142 and 144, it is possible to prevent the upward deformation of the part of the exterior member 20 positioned above the electrode portion with each of the tabs 150 and 152.

In this embodiment, although a description has been given of a case in which each of the tabs 150 and 152 is formed to have a rectangular shape, this embodiment is not limited thereto.

For example, each of the tabs 150 and 152 may be formed to have a T-shape. In this case, it is possible to increase connection strength between each of the tabs 150 and 152 and the exterior member 20.

The deformation a part of the exterior member 20 positioned below each of the electrode portions 142 and 144 is suppressed by the printed circuit board, on which the circuit protection device 140 is mounted.

### Tenth Embodiment

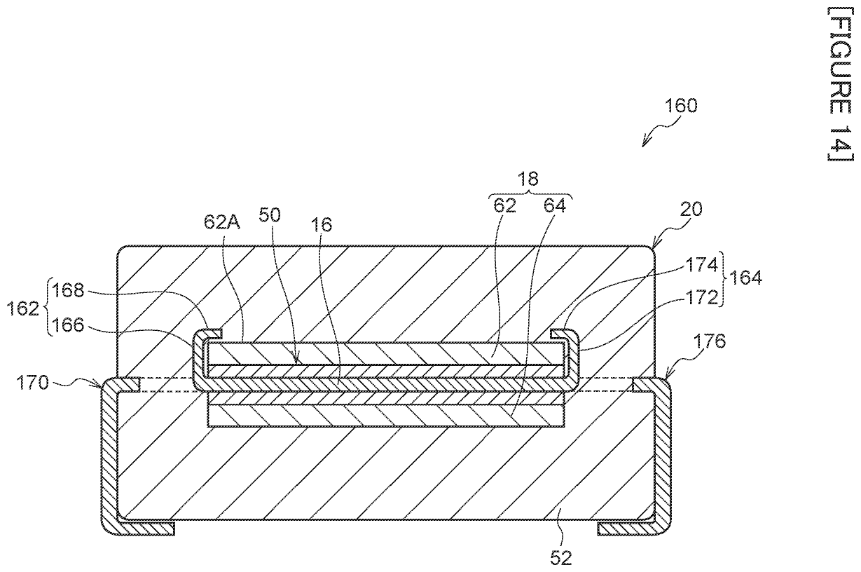

FIG. 14 is a sectional view showing a circuit protection device 160 according to a tenth embodiment. The tenth embodiment will be described with reference to FIG. 14.

Components that are the same as or similar to those in the respective embodiments described above will be assigned the same reference numerals, and a description thereof shall be omitted. Description will be given of components that are different from those in the respective embodiments described above.

In the circuit protection device 160 according to the tenth embodiment, compared with the circuit protection device 140 according to the nineth embodiment, the structure of each of tabs 162 and 164 is different.

In other words, each of the tabs 162 and 164 in the circuit protection device 160 according to the tenth embodiment is longer than each of the tabs 150 and 152 in the nineth embodiment.

A base end portion of the first tab 162 is bend along a first end surface of the first plate body 62, and the first tab 162 has a first end-surface extended portion 166 that extends along the first end surface of the first plate body 62. In the first tab 162, a tip-end portion of the first end-surface extended portion 166 is bent along a front surface 62A of the first plate body 62, and the first tab 162 has a first front-surface extended portion 168 that extends along the front surface 62A of the first plate body 62.

With such a configuration, the first tab 162 clamps a first end portion of the first plate body 62, which is fixed to the element portion 16 with the adhesive 50, by a first electrode portion 170 and the first front-surface extended portion 168.

In addition, a base end portion of the second tab 164 is bend along a second end surface of the first plate body 62, and the second tab 164 has a second end surface extended portion 172 that extends along the second end surface of the first plate body 62. In the second tab 164, a tip-end portion of the second end surface extended portion 172 is bent along the front surface 62A of the first plate body 62, and the second tab 164 has a second front-surface extended portion 174 that extends along the front surface 62A of the first plate body 62.

With such a configuration, the second tab 164 clamps a second end portion of the first plate body 62, which is fixed to the element portion 16 with the adhesive 50, by a second electrode portion 176 and the second front-surface extended portion 174.

### Operations and Effects

Next, the operational advantages of this embodiment will be described.

Also in this embodiment, for the configurations that are the same as or similar to those in the respective embodiments described above, it is possible to achieve the operational advantages similar to those in the respective embodiments described above.

In addition, each of the tabs 162 and 164 in the circuit protection device 160 in this embodiment clamps the end portion of the first plate body 62, which is fixed to the element portion 16 with the adhesive 50. In addition, both tabs 162 and 164 hold the first plate body 62, which is fixed to the element portion 16 with the adhesive 50, from both end portions.

Therefore, even if the pressure and the impact generated when the element portion 16 is fused is applied to the first plate body 62, it is possible to suppress unexpected upward movement of the first plate body 62.

Although the embodiments of the present invention have been described in the above, the above-mentioned embodiments merely illustrate a part of application examples of the present invention, and the technical scope of the present invention is not intended to be limited to the specific configurations of the above-described embodiments.

In these embodiments, each of the plate bodies 40 and 42 may be arranged directly to the element portion 16 and each of the electrode portions 12 and 14 without using the inorganic adhesive 50 therebetween.

The present application claims a priority based on Japanese Patent Application No. 2021-166878 filed with the Japan Patent Office on Oct. 11, 2021. All the contents of this application are hereby incorporated by reference.

### REFERENCE SIGNS LIST

10, 60, 70, 140, 160 circuit protection device
10A upper surface
10B lower surface
10C first side surface
10D second side surface
12, 142, 170 first electrode portion
14, 144, 176 second electrode portion
16 element portion
17 narrow portion
18, 72, 92, 102, 112, 122, 132 plate body
20 exterior member
22 first extending portion
24 first side-surface extended portion
26 first lower-surface extended portion
30 second extending portion
32 second side-surface extended portion
34 second lower-surface extended portion
40, 62 first plate body
42, 64 second plate body
50 adhesive
52 molding material
76 groove
146 first surface
150, 162 first tab
152, 164 second tab

1-10. (canceled)

11. A circuit protection device comprising:
a pair of electrode portions;
an element portion provided between both of the electrode portions;
a plate body arranged so as to extend along the element portion, the plate body being made of an insulator; and
an exterior member configured to cover the element portion and the plate body.

12. The circuit protection device according to claim 11, wherein
the plate body has a first plate body arranged on a first side of the element portion and a second plate body arranged on a second side of the element portion.

13. The circuit protection device according to claim 11, wherein
the plate body is made of an inorganic material.

14. The circuit protection device according to claim 11, wherein
the element portion is formed of a narrow portion formed in an elongated metal plate, and
the electrode portions include a first electrode portion formed on a first side of the metal plate bounded by the narrow portion and a second electrode portion formed on a second side of the metal plate bounded by the narrow portion.

15. The circuit protection device according to claim 11, wherein
the element portion is made of phosphor bronze.

16. The circuit protection device according to claim 11, wherein
the plate body is fixed to the element portion via an inorganic adhesive.

17. The circuit protection device according to claim 11, wherein
the exterior member is made of a molding material, the molding material being in close contact with the plate body and the electrode portions, and
at least one of the electrode portions has a tab, the tab being projected from a first surface of the electrode portion so as to be inserted into the molding material.

18. The circuit protection device according to claim 17, wherein
an extending portion of the electrode portion extending out from the exterior member has a side-surface extended portion and a lower-surface extended portion, the side-surface extended portion extending along a side surface of the exterior member, and the lower-surface extended portion extending along a lower surface of the exterior member, and
the tab projects out from the electrode portion towards an upper surface side of the exterior member.

19. The circuit protection device according to claim 11, wherein
the plate body has a plate thickness of 100 μm or less.

20. The circuit protection device according to claim 11, wherein
the plate body has a groove in a surface.
